(19) United States
(12) Patent Application Publication
(10) Pub. No.: US 2025/0321474 A1
(43) Pub. Date: Oct. 16, 2025

(54) LIGHT SOURCE SYSTEM

(71) Applicant: Qisda Corporation, Taoyuan City (TW)

(72) Inventors: Kai-Jiun WANG, Taoyuan City (TW); Yi-Ling LO, Taoyuan City (TW)

(73) Assignee: Qisda Corporation, Taoyuan City (TW)

(21) Appl. No.: 19/098,091

(22) Filed: Apr. 2, 2025

(30) Foreign Application Priority Data
Apr. 11, 2024 (CN) 202420747131.5

(51) Int. Cl. G03B 21/20

(52) U.S. Cl. CPC G03B 21/208; G03B 21/2013; G03B 21/2066

(57) ABSTRACT

A light source system includes collimating element, first light source, second light source, first refracting element, second refracting element and reflective element. The first light source is disposed on a first side of an optical axis. The second light source is disposed on the second side of the optical axis. The first refracting element is disposed on the first side or the second side and reflects a first light beam. The second refracting element is disposed on the other one of the first side and the second side of the optical axis and reflects a second light beam. The reflective element reflects the light beam. An adaxial one of the first refracting element and the second refracting element is closer to the optical axis than an abaxial one of the first refracting element and the second refracting element, and the refracting elements are different in tilt angle.

This application claims the benefit of People's Republic of China application Serial No. 202420747131.5, filed on Apr. 11, 2024, the subject matter of which is incorporated herein by reference.

### TECHNICAL FIELD

The disclosure relates in general to a light source system.

### BACKGROUND

A light source system generally used in projectors must include a plurality of optical elements with different functions in order to provide illumination light to a projection module. However, these optical components often make the projector or light source system too large in volume. Therefore, proposing a light source system that may improve the aforementioned conventional problems is one of the goals of those in this technical field.

### SUMMARY

According to an embodiment, a light source system is provided. The light source system includes a collimating element, a first light source, a second light source, a first refracting element, a second refracting element and a reflective module. The collimating element has an optical axis. The first light source is disposed on a first side or a second side of the optical axis and configured to emit a first light beam, wherein the first side and the second side are two opposite sides of the optical axis respectively. The second light source is disposed on the first side or the second side of the optical axis and configured to emit a second light beam. The first refracting element is disposed on one of the first side and the second side of the optical axis and configure to reflect the first light beam. The second refracting element is disposed on the other of the first side and the second side of the optical axis and configure to reflect the second light beam. The reflective module is configured to reflect the first light beam reflected by the first refracting element and the second light beam reflected by the second refracting element. An adaxial one of the first refracting element and the second refracting element is closer to the optical axis than an abaxial one of the first refracting element and the second refracting element, and the first refracting element and the second refracting element are different in tilt angle. The first light source is a light source that emits polychromatic light.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1A illustrates a schematic diagram of a light source system according to an embodiment of the present invention;

FIG. 1B illustrates a schematic diagram of a reflective module in FIG. 1A;

FIG. 1C illustrates a schematic diagram of a first lens array in FIG. 1A;

FIG. 2A illustrates a schematic diagram of the first light spots of the first light beam of FIG. 1A projected on the reflective module;

FIG. 2B illustrates a schematic diagram of the second light spots of the second light beam of FIG. 1A projected on the reflective module;

FIG. 2C illustrates a schematic diagram of the overlapping of the first light spots of FIG. 2A and the second light spot of FIG. 2B;

FIG. 3 illustrates a schematic diagram of a first light spot projected by the first light beam and a second light spot projected by the second light beam of the light source system overlapping according to a comparative example;

FIG. 4 illustrates a schematic diagram of a light source system according to another embodiment of the present invention;

FIG. 5 illustrates a schematic diagram of a light source system according to another embodiment of the present invention;

FIG. 6 illustrates a schematic diagram of a light source system according to another embodiment of the present invention; and

FIG. 7 illustrates a schematic diagram of a light source system according to another embodiment of the present invention.

### DETAILED DESCRIPTION

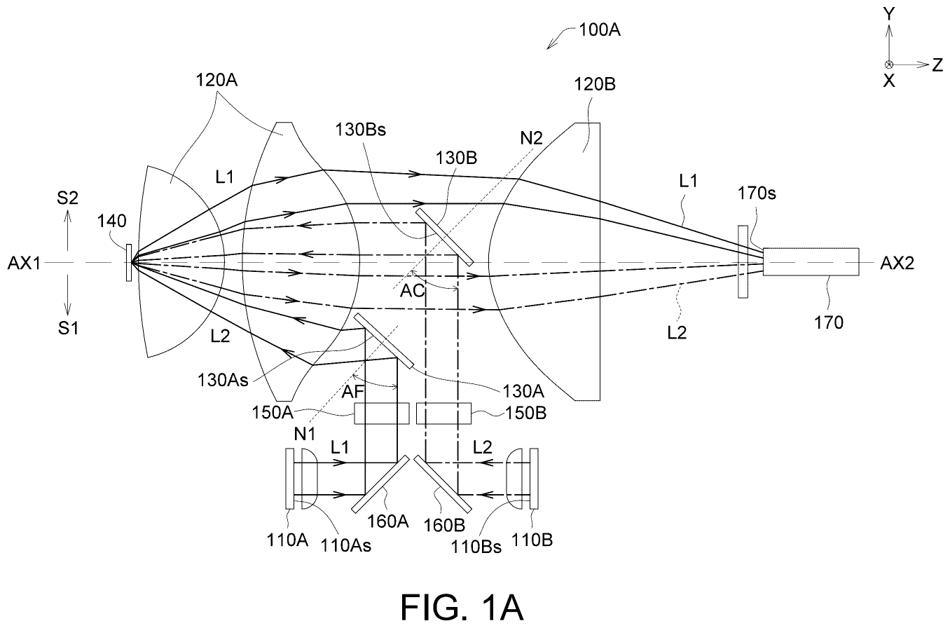

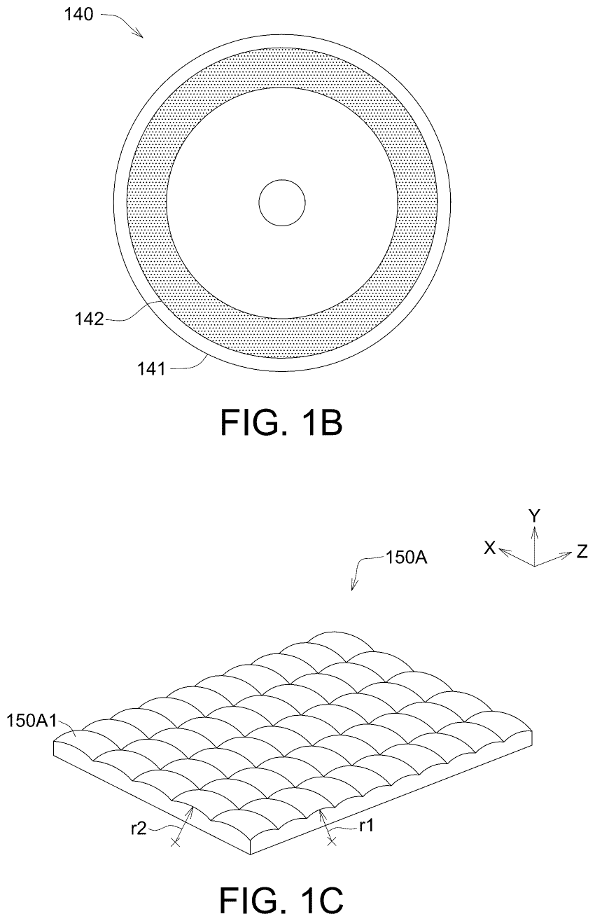

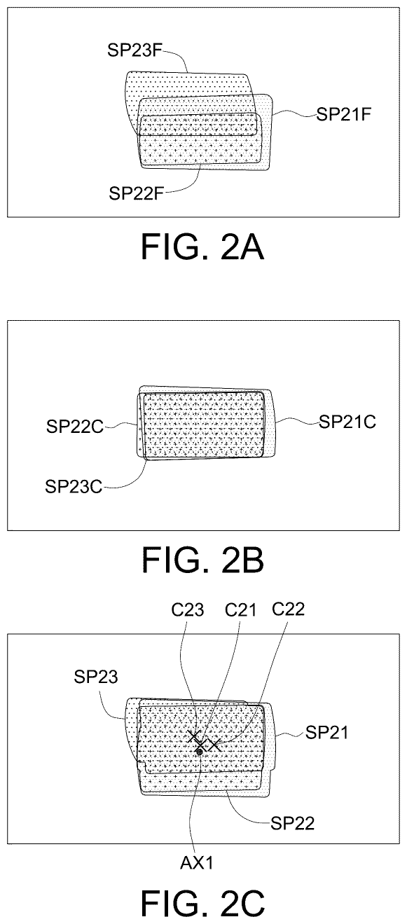

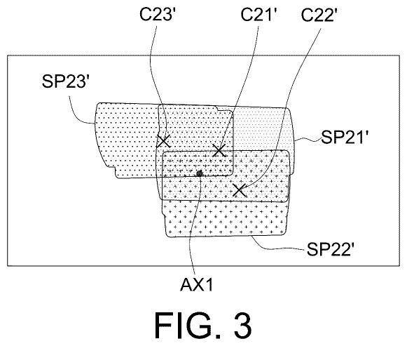

Referring to FIGS. 1A to 1C, 2 and 3. FIG. 1A illustrates a schematic diagram of a light source system 100A according to an embodiment of the present invention, FIG. 1B illustrates a schematic diagram of a reflective module 140 in FIG. 1A, FIG. 1C illustrates a schematic diagram of a first lens array 150A in FIG. 1A, FIG. 2A illustrates a schematic diagram of the first light spots SP21F to SP23F of the first light beam L1 of FIG. 1A projected on the reflective module 140, FIG. 2B illustrates a schematic diagram of the second light spots SP21C to SP23C of the second light beam L2 of FIG. 1A projected on the reflective module 140, and FIG. 2C illustrates a schematic diagram of the overlapping of the first light spots SP21F to SP23F of FIG. 2A and the second light spot SP21C to SP23C of FIG. 2B,, and FIG. 3 illustrates a schematic diagram of a first light spot projected by the first light beam and a second light spot projected by the second light beam of the light source system overlapping according to a comparative example. The Z axis illustrated in the figures. is, for example, parallel to an optical axis AX1 and perpendicular to the XY plane.

As illustrated in FIG. 1A, the light source system 100A includes a first light source 110A, a second light source 110B, a collimating element (or collimator) 120A, a condensing element 120B, a first refracting element 130A, a second refracting element 130B, a reflective module 140, a first lens array 150A, a second lens array 150B, a first reflective element 160A, a second reflective element 160B and a light integrator 170.

As illustrated in FIGS. 1A and 2A, the collimating element 120A has an optical axis AX1. The first light source 110A is disposed on a first side S1 or a second side S2 of the optical axis AX1 and is configured to emit the first light beam L1, wherein the first side S1 and the second side S2 are located on two opposite sides of the optical axis AX1 respectively. The second light source 110B is disposed on the first side S1 or the second side of the optical axis AX1 and is configured to emit the second light beam L2. The first refracting element 130A is disposed on one of the first side S1 and the second side S2 of the optical axis AX1 and is configured to reflect the first light beam L1. The second refracting element 130B is disposed on the other one of the first side S1 and the second side S2 of the optical axis AX1 and is configured to reflect the second light beam L2. The reflective module 140 is configured to reflect the first light beam L1 reflected from the first refracting element 130A and the second light beam L2 reflected from the second refracting element 130B. An adaxial one of the first refracting element 130A and the second refracting element 130B is closer to the optical axis AX1 than an abaxial one of the first refracting element 130A and the second refracting element 130B. In the embodiment, the first refracting element 130A and the second refracting element 130B are different in tilt angle, thereby adjusting the position of the first light spot projected by the first light beam L1 on the reflective module 140 and adjusting the projection of the second light spot projected by the second light beam L2 on the reflective module 140 to increase the overlapping area of the first light spot and the second light spot, improve aberration problem and decentering problem.

Furthermore, as illustrated in FIG. 3, the first light spot projected by the first light beam and the second light spot projected by the second light beam of the light source system of the comparative example have poor overlap. The light spot SP21′ shown in FIG. 3 is, for example, an overlapping light spot of the first light beam (for example, a first one of red light, green light and blue light) and the second light beam (for example, the first one of the red light, the green light and the blue light), the light spot SP22′ is, for example, an overlapping light spot of the first light beam (for example, a second of the red light, the green light and the blue light) and the second light beam (for example, the second one of the red light, the green light and the blue light), and the light spot SP23′ is, for example, an overlapping light spot of the first light beam (for example, a third one of the red light, the green light and the blue light) and the second light beam (for example, the third one of the red light, the green light and the blue light). As can be seen from the figure, the deviation among the geometric centers of the overlapping light spots C21′, C22′ and C23′ of the comparison group is greater (i.e., the overlap is poor).

As illustrated in FIG. 2A, the first light beam L1 (e.g., the light beam of the abaxial one) includes the red light, the green light and the blue light, which are projected onto the reflective module 140 to form first light spots SP21F to SP23F respectively. As illustrated in FIG. 2B, the second light beam L1 (e.g., the light beam of the adaxial one) includes the red light, the green light and the blue light, which are projected onto the reflective module 140 to form second light spots SP21C to SP23C, respectively. As illustrated in FIG. 2C, the first light spots SP21F to SP23F formed by the first light beam L1 overlap with the second light spots SP21C to SP23C formed by the second light beam L2. For example, the first light spot SP21F overlaps with the second light spot SP21C to form an overlapping light spot SP21, the first light spot SP22F overlaps with the second light spot SP22C to form an overlapping light spot SP22, and the first light spot SP23F overlaps with the second light spot SP23C to form an overlapping light spot SP23.

Compared with the comparison group, as illustrated in FIG. 2C, the light source system 100A in the embodiment of the present invention can increase the overlap of the overlapping light spots SP21 to SP23 by the abaxial one and the adaxial one are different in tilt angle, thereby increasing the overlap of the overlapping light spots SP21 to SP23 and improving the problems of the aberration and the decentering. In detail, the deviations among the geometric center C21 of the overlapping light spot SP21, the geometric center C22 of the overlapping light spot SP22 and the geometric center C23 of the overlapping light spot SP23 are small and close to the optical axis AX1; or, the geometric center C21 of the overlapping light spot SP21, the geometric center C22 of the overlapping light spot SP22 and the geometric center C23 of the overlapping light spot SP23 may even overlap and/or overlap on the optical axis AX1.

In addition, due to the optical design of the light source system 100A, the conventional afocal system may be omitted, thereby reducing the size of the light source system 100A, making the light source system 100A more suitable for small or micro projectors.

As illustrated in FIG. 1A, the first light beam L1 emitted from the first light source 110A sequentially travels through the first reflective element 160A, the first lens array 150A, the first refracting element 130A, and the collimating element 120A to the reflective mold. group 140, and then reflected by the reflective module 140 and then sequentially travels through the collimating element 120A and the condensing element 120B to the light integrator 170. In addition, the second light beam L2 emitted from the second light source 110B travels to the reflective module 140 through the second reflective element 160B, the second lens array 150B, the second refracting element 130B, the collimating element 120A in sequence, and then travels to the light guide 170 through the collimating element 120A and the condensing element 120B in sequence after being reflected by the reflective module 140.

As illustrated in FIG. 1A, the first light source 110A is, for example, a light source capable of emitting polychromatic light, such as a polychromatic laser light source, and the first light beam L1 is a combination of at least one of the red light, the green light and the blue light. Similarly, the second light source 110B is, for example, a light source capable of emitting polychromatic light, such as a polychromatic light laser light source, and the second light beam L2 is a combination of at least one of the red light, the green light and the blue light.

As illustrated in FIG. 1A, the collimating element 120A is disposed opposite to the reflective module 140. The collimating element 120A can improve the collimation of the first light beam L1 and the second light beam L2 travelling therethrough. In an embodiment, the collimating element 150 is a collimating lens group including a plurality of lenses. The collimating lens group uses multiple lenses to achieve the collimation of the light beam.

As illustrated in FIG. 1A, the condensing element 120B is disposed between the light integrator 170 and the refracting element (the first refracting element 130A and/or the second refracting element 130B). The collimating element 120B can reduce the beam diameters of the first light beam L1 and the second light beam L2 travelling therethrough, so that the entire light spot of the first light beam L1 and the entire light spot of the second light beam L2 can be incident to an inside of the light integrator 170 from a light incident surface 170s of the light integrator 170.

As illustrated in FIG. 1A, since the first refracting element 130A and the second refracting element 130B are different are different in tilt angle, the symmetry or centering of the light spot incident on the light integrator 170 can be improved. In detail, the light spots of the first light beam L1 and the second light beam L2 incident on the light incident surface 170s of the light integrator 170 are highly symmetrical relative to the X-axis or the Y-axis, so the mixed light of the first light beam L1 and the second light beam L2 incident on the light incident surface 170s is more uniform, and accordingly it can improve the color uniformity of the projected image.

As illustrated in FIG. 1A, the abaxial inclination angle AF of the abaxial one of the first refracting element 130A and the second refracting element 130B is smaller than the adaxial inclination angle AC of the adaxial one. The “abaxial one” in this article is farther away from the optical axis AX1 than the “adaxial one” along the Y-axis (substantially perpendicular to the optical axis AX1). For example, the first refracting element 130A is further away from the optical axis AX1 than the second refracting element 130B (e.g., along the Y-axis which is substantially perpendicular to the optical axis AX1), so the first refracting element 130A is the abaxial one while the second refracting element 130B is the adaxial one. The first refracting element 130A has the abaxial inclination angle AF, and the second refracting element 130B has the adaxial inclination angle AC. Due to the first refracting element 130A being farther from the optical axis AX1 than the second refracting element 130B, the first light beam L1 is farther from the optical axis AX1 than the second light beam L2, and the first light beam L1 reflected by the reflective module 140 is farther from the optical axis AX1 than the second light beam L2 reflected by the group 140.

As illustrated in FIG. 1A, the abaxial inclination angle AF is smaller than the adaxial inclination angle AC. In the present embodiment, a light incident surface 130As of the first refracting element 130A has a first normal line N1, and the abaxial inclination angle AF is, for example, an angle between the first normal line N1 and the first light beam L1 incident on the light incident surface. A light incident surface 130Bs of the second refracting element 130B has a second normal line N2, and the adaxial inclination angle AC is, for example, an angle between the second normal line N2 and the second light beam L2 incident on the light incident surface 130Bs. In an embodiment, the abaxial inclination angle AF ranges between, for example, 40 degrees (including 40 degrees) and 45 degrees (excluding 45 degrees), for example, 43.5 degrees, and the adaxial inclination angle AC is, for example, 45 degrees.

By reducing the abaxial inclination angle AF of the abaxial one (for example, from 45 degrees to 43.5 degrees), the geometric center of the area where the first light spot SP21F to SP23F (illustrated in FIG. 2A) of the first light beam L1 is projected on the reflective module 140 can be closer to the optical axis AX1, and an overlapping area between the area where the first light spots SP21F to SP23F is projected on the reflective module 140 and an area where the second light spots SP21C to SP23C (illustrated in FIG. 2B) of the second light beam L2 is projected on the reflective module 140 can be increased.

As illustrated in FIGS. 1A and 1B, the reflective module 140 is a diffuser wheel (DW), such as a reflective-type diffuser wheel. The reflective module 140 includes a body 141 and a diffusion layer 142. The diffusion layer 142 is formed on the body 141 and is in a closed-ring shape, such as an O-ring. In another embodiment, as illustrated in FIG. 1B, the diffusion layer 142 may cover the entire of an incident surface of the body 141 (the surface facing the +Z axis illustrated in FIG. 1A). The body 141 is, for example, a reflective element, such as a reflector, a metal component, etc., and the diffusion layer 142 is, for example, a coating or a machined layer (e.g., frosted, beaded, etc.). The first light beam L1 and the second light beam L2 incident on the diffusion layer 142 are scattered and/or reflected. The collimating element 120A can improve the collimation of the first light beam L1 and the second light beam L2 travelling therethrough. In addition, the first refracting element 130A and the second refracting element 130B are reflectors that can reflect light beams of different wavelengths, such as the red light, the green light and the blue light.

The reflective module 140 may be a static reflective module or a dynamic reflective module. For dynamic reflective module, the dynamic reflective module 140 can rotate around the optical axis AX1 relative to the collimating element 120A or other components of the light source system 100. For a static reflective module, the reflective module 140 is fixed relative to the collimating element 120A or other components of the light source system 100. In addition, in another embodiment, the diffusion layer 142 may be omitted from the reflective module 140 in FIG. 1B. As illustrated in FIG. 1A, the first lens array 150A is disposed between the first light source 110A and the first refracting element 130A and is configured to guide the first light beam L1 to the first refracting element 130A. The second lens array 150B is disposed between the second light source 110B and the second refracting element 130B and is configured to guide the second light beam L2 to the second refracting element 130B.

As illustrated in FIG. 1C, the first lens array 150A may uniformize (or homogenize) the light beam. Furthermore, when the coherence of the first light beam L1 is high, the light spots projected on the reflective module 140 appears as a plurality of obvious light spots. The first lens array 150A may diffuse the first light beam L1 traveling through the lens array, so that the light spots projected on the reflective module 140 are more uniform (without obvious light spots). Similar to the first lens array 150A, the second lens array 150B may also uniformize (or homogenize) the light beam. Furthermore, when the coherence of the second light beam L2 is high, the light spots projected on the reflective module 140 appears as a plurality of obvious light spots. The second lens array 150B may diffuse the second light beam L2 traveling through the lens array, so that the light spots projected on the reflective module 140 are more uniform (without obvious light spots).

As illustrated in FIG. 1C, the first lens array 150A includes at least one lenslet 150A1. A plurality of the lenslets 150A1 is disposed in an array (on the XZ plane). Each lenslet 150A1 has a first curvature radius r1 on the YZ plane and a second curvature radius r2 on the XY plane, wherein the first curvature radius r1 and the second curvature radius r2 may be the same or different. Similarly, the second lens array 150B also includes at least one lenslet (not illustrated). The lenslet of the lens array 150B has the structure the same as or similar to that of the lenslet 150A1 of the first lens array 150A, and it will not be described again here. In addition, the curvature radius (e.g., the first curvature radius and/or the second curvature radius) of the lenslet of the lens array of the abaxial one is less than the curvature radius of the lenslet of the lens array of the adaxial one. In the present embodiment, the curvature radius (for example, the first curvature radius and/or the second curvature radius) of the lenslet 150A1 corresponding to the first refracting element 130A (abaxial one) is less than the curvature radius of the lenslet (not illustrated) of the second refracting element 130B (adaxial one).

In an embodiment, the area of the lenslet corresponding to the lens array of the abaxial one is less than the area of the lenslet corresponding to the lens array of the adaxial one.

Due to aberration, the deformation of the light spot formed by traveling through the abaxial one (for example, the first refracting element 130A in FIG. 1A) is greater than that of the light spot formed by traveling through the adaxial one (for example, the second refracting element 130B in FIG. 1A), and thus it results in poor optical-mechanical efficiency. However, by the curvature radius of the lenslet corresponding to the abaxial one is less than the curvature radius of the lenslet corresponding to the adaxial one and/or the area of the lenslet corresponding to the abaxial one is less than the area of the lenslet corresponding to the adaxial one in the embodiment of the present invention, so that the light spot formed by traveling through the abaxial one is similar to the light spot formed by traveling through the adaxial one, and it may improve the optical-mechanical efficiency.

As illustrated in FIG. 1A, the first reflective element 160A is disposed relative to the first light source 110A and is configured to reflect the first light beam L1. The second reflective element 160B is disposed relative to the second light source 110B and configured to reflect the second light beam L2. Furthermore, the first reflective element 160A and the second reflective element 160B are reflective mirrors. In another embodiment, the light source system 100A may omit the first reflective element 160A, and the first light-emitting surface 110As of the first light source 110A may face the first lens array 150A. Similarly, in another embodiment, the light source system 100A may omit the second reflective element 160B, and the second light-emitting surface 110Bs of the second light source 110B may face the second lens array 150B.

As illustrated in FIG. 1A, the light integrator 170 is disposed downstream of the condensing element 120B and has a central axis AX2. The central axis AX2 and the optical axis AX1 may substantially overlap, but this is not intended to limit the embodiment of the present invention. The light beam incident into the light integrator 170 may be reflected for multiple times in the light integrator 170 to uniformly mix the light. In an embodiment, the light integrator 170 is, for example, a light pipe, a light rod, etc.

In the light source system 100A of the aforementioned embodiment, the first refracting element 130A is the abaxial one and disposed on the first side S1, and the second refracting element 130B is the adaxial one and disposed on the second side S2; however, this is not intended to limit the embodiments of the present invention. In another embodiment, the first refracting element 130A may be the adaxial one and the second refracting element 130B may be the abaxial one. In other embodiments, the first refracting element 130A may be disposed on the second side S2, and the second refracting element 130B may be disposed on the first side S1.

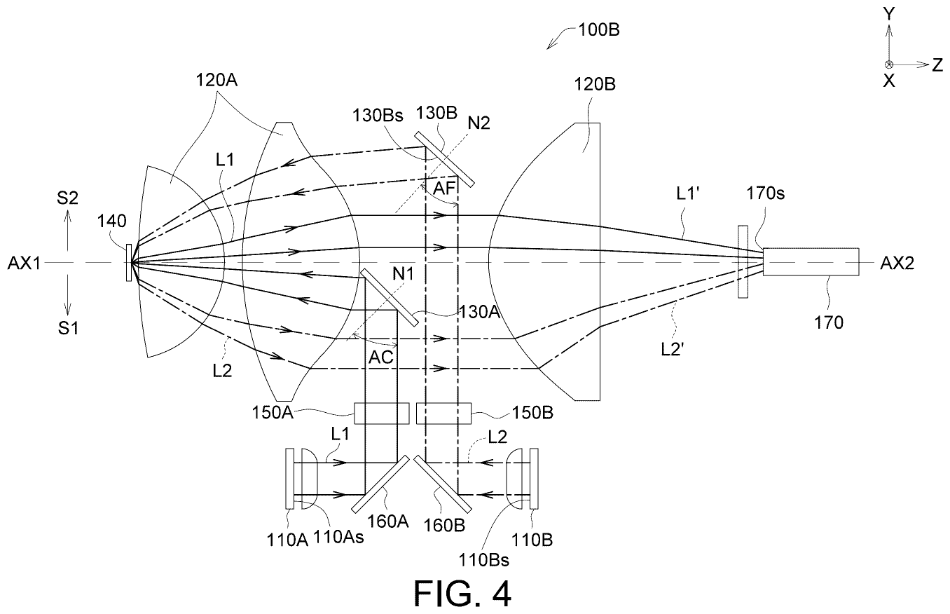

Referring to FIG. 4, FIG. 4 illustrates a schematic diagram of a light source system 100B according to another embodiment of the present invention. The light source system 100B includes the first light source 110A, the second light source 110B, the collimating element 120A, the condensing element 120B, the first refracting element 130A, the second refracting element 130B, the reflective module 140, the first lens array 150A, the second lens array 150B, the first reflective element 160A, the second reflective component 160B and the light integrator 170. The light source system 100B includes the technical features the same as or similar to that of the light source system 100A, and the difference is that the first refracting element 130A is disposed on the first side S1 and is the adaxial one, while the second refracting element 130B is disposed on the second side S2 and is the abaxial one.

As illustrated in FIG. 4, the abaxial inclination angle AF is less than the adaxial inclination angle AC. In the present embodiment, the light incident surface 130As of the first refracting element 130A has the first normal line N1, and the adaxial inclination angle AC is, for example, the angle between the first normal line N1 and the first light beam L1 incident on the light incident surface 130As. The light incident surface 130Bs of the second refracting element 130B has the second normal line N2, and the abaxial inclination angle AF is, for example, the angle between the second normal line N2 and the second light beam L2 incident on the light incident surface 130Bs. In an embodiment, the abaxial inclination angle AF is, for example, between 40 degrees (including end point) and 45 degrees (including end point), such as 43.5 degrees, and the adaxial inclination angle AC is, for example, 45 degrees.

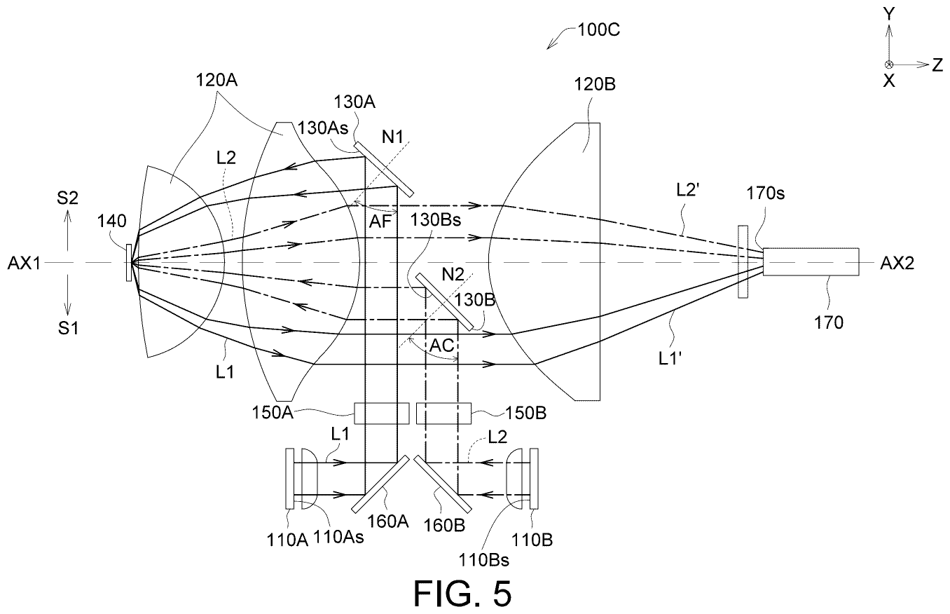

Referring to FIG. 5, FIG. 5 illustrates a schematic diagram of a light source system 100C according to another embodiment of the present invention. The light source system 100C includes the first light source 110A, the second light source 110B, the collimating element 120A, the condensing element 120B, the first refracting element 130A, the second refracting element 130B, the reflective module 140, the first lens array 150A, the second lens array 150B, the first reflective element 160A, the second reflective component 160B and the light integrator 170. The light source system 100C includes the technical features the same as or similar to that of the light source system 100A, and the difference is that the first refracting element 130A is disposed on the second side S2 and is the abaxial one, while the second refracting element 130B is disposed on the first side S1 and is the adaxial one.

As illustrated in FIG. 5, the abaxial inclination angle AF is less than the adaxial inclination angle AC. In the present embodiment, the light incident surface 130As of the first refracting element 130A has the first normal line N1, and the abaxial inclination angle AF is, for example, the angle between the first normal line N1 and the first light beam L1 incident on the light incident surface 130As. The light incident surface 130Bs of the second refracting element 130B has the second normal line N2, and the adaxial inclination angle AC is, for example, the angle between the second normal line N2 and the second light beam L2 incident on the light incident surface 130Bs. In an embodiment, the abaxial inclination angle AF is, for example, between 40 degrees (including end point) and 45 degrees (including end point), such as 43.5 degrees, and the adaxial inclination angle AC is, for example, 45 degrees.

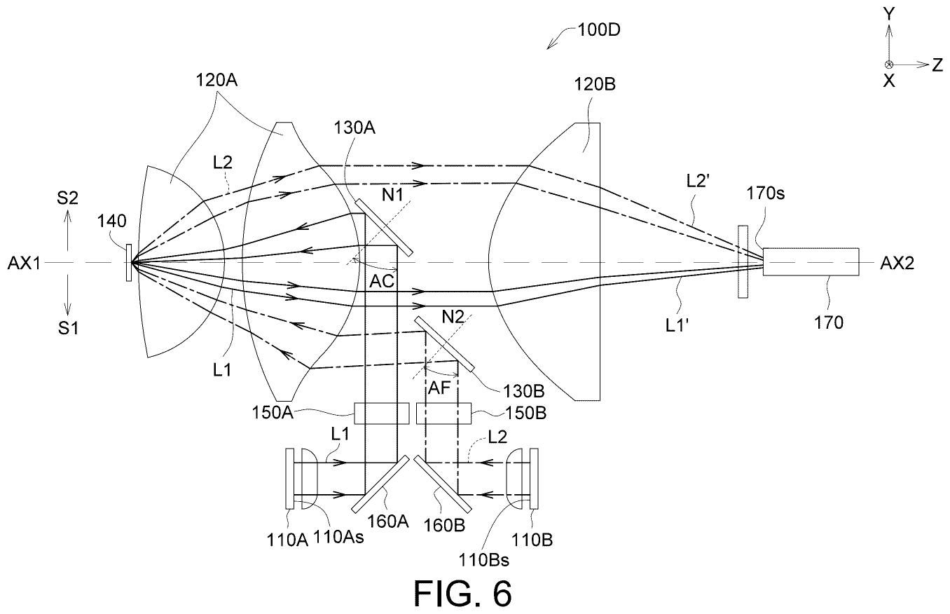

Referring to FIG.6, FIG. 6 illustrates a schematic diagram of a light source system 100D according to another embodiment of the present invention. The light source system 100D includes the first light source 110A, the second light source 110B, the collimating element 120A, the condensing element 120B, the first refracting element 130A, the second refracting element 130B, the reflective module 140, the first lens array 150A, the second lens array 150B, the first reflective element 160A, the second reflective component 160B and the light integrator 170. The light source system 100D includes the technical features the same as or similar to that of the light source system 100A, and the difference is that the first refracting element 130A is disposed on the second side S2 and is the adaxial one, while the second refracting element 130B is disposed on the first side S1 and is the abaxial one.

As illustrated in FIG. 6, the abaxial inclination angle AF is less than the adaxial inclination angle AC. In the present embodiment, the light incident surface 130As of the first refracting element 130A has the first normal line N1, and the adaxial inclination angle AC is, for example, the angle between the first normal line N1 and the first light beam L1 incident on the light incident surface 130As. The light incident surface 130Bs of the second refracting element 130B has the second normal line N2, and the abaxial inclination angle AF is, for example, the angle between the second normal line N2 and the second light beam L2 incident on the light incident surface 130Bs. In an embodiment, the abaxial inclination angle AF ranges, for example, between 40 degrees (including end point) and 45 degrees (including end point), such as 43.5degrees, and the adaxial inclination angle AC is, for example, 45 degrees.

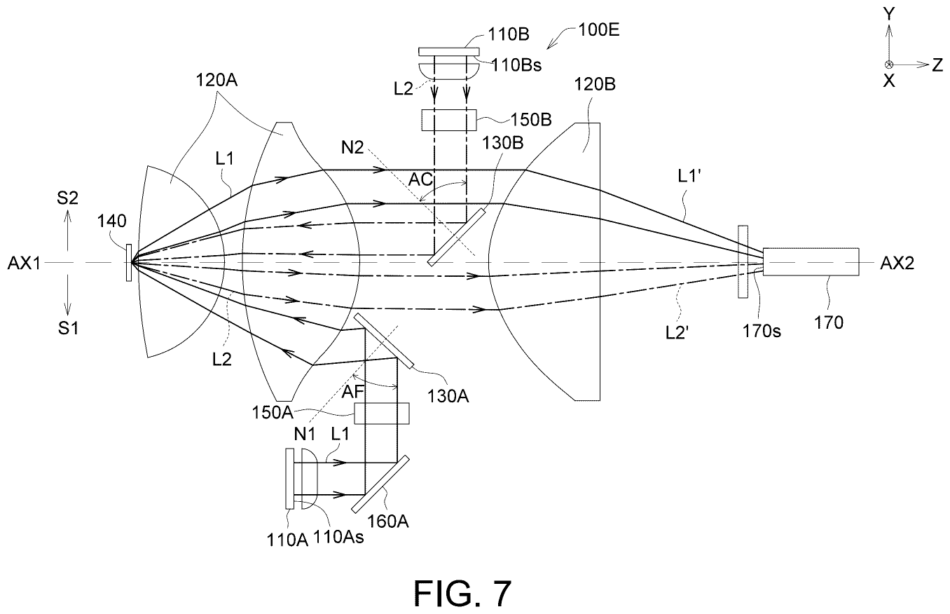

Referring to FIG.7, FIG. 7 illustrates a schematic diagram of a light source system 100E according to another embodiment of the present invention. The light source system 100E includes the first light source 110A, the second light source 110B, the collimating element 120A, the condensing element 120B, the first refracting element 130A, the second refracting element 130B, the reflective module 140, the first lens array 150A, the second lens array 150B, the first reflective element 160A, the second reflective component 160B and the light integrator 170. The light source system 100E includes the technical features the same as or similar to that of the light source system 100A, and the difference is that the second light source 110B, the second lens array 150B and the second refracting element 130B may be disposed on the second side S2, and the light source system 100E may omit the second reflective element 160B.

In the present embodiment, the second refracting element 130B of the light source system 100E is the adaxial one. In another embodiment, the first light source 110A, the first lens array 150A and the first refracting element 130A of the light source system 100A in FIG. 1A may be disposed on the second side S2, and the first refracting element 130A is the abaxial one, and the second refracting element 130B is the adaxial one. In other embodiment, the first light source 110A, the first lens array 150A and the first refracting element 130A of the light source system 100A in FIG. 1A may be disposed on the second side S2, and the first refracting element 130A is the adaxial one, and the second refracting element 130B is the abaxial one.

In summary, the embodiment of the present invention proposes a light source system including two light sources and two refracting elements. In an embodiment, the two light sources may be disposed on the same side or on two opposite sides of an optical axis (for example, the optical axis of a collimating element). When the two light sources are disposed on the same side of the optical axis, two refracting elements are respectively disposed on two opposite sides of the optical axis, wherein one of the two refracting elements is the abaxial one and the other of the two refracting elements is the adaxial one. When the second light source is disposed on two opposite sides of the optical axis, the two refracting elements are respectively disposed on two opposite sides of the optical axis, one of the two refracting elements is the abaxial one and the other one of the two refracting elements is the adaxial one. In an embodiment, the inclination angles of the abaxial one and the adaxial one are different, and accordingly the spot position of the light beam emitted by each light source may be adjusted, thereby improving aberration and decentering problems.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A light source system, comprising:
a collimating element having an optical axis;
a first light source disposed on a first side or a second side of the optical axis and configured to emit a first light beam, wherein the first side and the second side are two opposite sides of the optical axis respectively;
a second light source disposed on the first side or the second side of the optical axis and configured to emit a second light beam;
a first refracting element disposed on one of the first side and the second side of the optical axis and configure to reflect the first light beam;
a second refracting element disposed on the other of the first side and the second side of the optical axis and configure to reflect the second light beam; and
a reflective module configured to reflect the first light beam reflected by the first refracting element and the second light beam reflected by the second refracting element;
wherein an adaxial one of the first refracting element and the second refracting element is closer to the optical axis than an abaxial one of the first refracting element and the second refracting element, and the first refracting element and the second refracting element are different in tilt angle;
wherein the first light source is a light source that emits polychromatic light.

2. The light source system according to claim 1, wherein an abaxial inclination angle of the abaxial one is less than an adaxial inclination angle of the adaxial one.

3. The light source system according to claim 2, wherein the abaxial inclination angle ranges between 40 degrees and 45 degrees.

4. The light source system according to claim 1, further comprising:
a light integrator disposed downstream of the reflective module and having a central axis;
wherein the central axis substantially overlaps with the optical axis.

5. The light source system according to claim 1, further comprising:
a first lens array disposed between the first light source and the first refracting element and configured to reflect the first light beam to the first refracting element; and
a second lens array disposed between the second light source and the second refracting element and configured to reflect the second light beam to the second refracting element.

6. The light source system according to claim 5, wherein the first lens array and the second lens array each comprising a lenslet; a curvature radius of the lenslet of the first lens array or the second lens array corresponding to the abaxial one is less than a curvature radius of the lenslet of the first lens array or the second lens array corresponding to the adaxial one.

7. The light source system according to claim 1, further comprising:
a first reflective element disposed relative to the first light source and configured to reflect the first light beam; and
a second reflective element disposed relative to the second light source and configured to reflect the second light beam.

8. The light source system according to claim 1, wherein the first light source has a first light-emitting surface, the second light source has a second light-emitting surface, and the first light-emitting surface and the second light-emitting surface face towards two opposite directions respectively.

9. The light source system according to claim 1, wherein the reflective module is a diffuser wheel (DW).

10. The light source system according to claim 9, wherein the diffuser wheel is a reflective-type diffuser wheel.

11. The light source system according to claim 1, wherein the diffusion wheel includes a body and a diffusion layer, and the diffusion layer is formed on the body and is in a closed-ring shape.

12. The light source system according to claim 1, wherein the diffusion wheel includes a body and a diffusion layer, and the diffusion layer is formed on the body and covers entire of an incident surface of the body.

13. The light source system according to claim 1, wherein the first refracting element and the second refracting element are reflective mirrors.

14. The light source system according to claim 1, further comprising:
a light integrator; and
a condensing element;
wherein the condensing element is disposed between the light integrator and the first refracting element.

15. The light source system according to claim 1, further comprising:
a condensing element;
wherein the first refracting element and the second refracting element are disposed between the collimating element and the condensing element.

16. The light source system according to claim 15, wherein the condensing element is configured to reduce a beam diameter of the first light beam and a beam diameter of the second light beam traveling through the condensing element, so that entire light spot of the first light beam and entire light spot of the second light beam are be incident into the light integrator from a light incident surface of the light integrator.
